(19) United States
(12) Patent Application Publication
(10) Pub. No.: US 2018/0135626 A1
(43) Pub. Date: May 17, 2018

(54) POSITIVE DISPLACEMENT PUMP ASSEMBLY FOR POWERTRAIN SYSTEMS AND HYDRAULIC CONTROL SYSTEM INCORPORATING THE SAME

(71) Applicant: BorgWarner Inc., Auburn Hills, MI (US)

(72) Inventors: Chengyun GUO, Novi, MI (US); Dmitriy SEMENOV, Rochester Hills, MI (US); Christopher SPANGLER, Rochester Hills, MI (US)

(21) Appl. No.: 15/566,805

(22) PCT Filed: Apr. 11, 2016
(86) PCT No.: PCT/US2016/026891

§ 371 Date: Oct. 16, 2017

Related U.S. Application Data
(60) Provisional application No. 62/148,771, filed on Apr. 17, 2015.

(51) Int. Cl. F04C 14/24; F04C 2/344; F16H 57/04; F16H 61/00

(52) U.S. Cl. CPC F04C 14/24; F04C 2/3446; F16H 57/0446; F16H 61/0025; F16H 2061/0037; F04C 2210/14; F04C 2270/18; F04C 2270/19; F04C 2270/20; F04C 2270/58

(57) ABSTRACT

A positive displacement pump assembly (28) for use with a vehicle powertrain system (10) includes a stator (30) having a chamber (32) and a vane pump (34) disposed in the chamber (32) and cooperating with the stator (30) so as to define at least three pumping regions (38) in the chamber (32) with each of the at least three pumping regions (38) having an inlet region (40) and an outlet region (42), wherein rotation of the vane pump (34) displaces fluid across each of the at 10 least three pumping regions (38) such that each outlet region (40) provides a separate source of fluid power to the powertrain system (10).

### CROSS-REFERENCE TO RELATED APPLICATION(S)

The present application claims priority to and all the benefits of U.S. Provisional Patent Application No. 62/148,771, filed on Apr. 17, 2015, which is hereby expressly incorporated herein by reference in its entirety.

### BACKGROUND OF INVENTION

### 1. Field of Invention

The present invention relates generally to powertrain systems and, more specifically, to a positive displacement pump assembly for powertrain systems and a hydraulic control system incorporating the same.

### 2. Description of the Related Art

Conventional vehicle powertrain systems known in the art typically include an engine in rotational communication with a transmission. The engine generates rotational torque which is selectively translated to the transmission which, in turn, translates rotational torque to one or more wheels. The transmission multiplies the rotational speed and torque generated by the engine through a series of predetermined gear sets, whereby changing between the gear sets enables a vehicle to travel at different vehicle speeds for a given engine speed. Thus, the gear sets of the transmission are configured such that the engine can operate at particularly desirable rotational speeds so as to optimize performance and efficiency.

In addition to changing between the gear sets, the transmission is also used to modulate engagement with the engine, whereby the transmission can selectively control engagement with the engine so as to facilitate vehicle operation. By way of example, torque translation between the engine and transmission is typically interrupted while a vehicle is parked or idling, or when the transmission changes between the gear sets. In some automatic transmissions, modulation is achieved via a hydrodynamic device such as a hydraulic torque converter. However, in other automatic transmissions, modulation is achieved with one or more electronically and/or hydraulically actuated clutches (sometimes referred to in the art as a “dual clutch” automatic transmission). Automatic transmissions are typically controlled using hydraulic fluid, and include a pump assembly, one or more solenoid valves, and an electronic controller. The pump assembly provides a source of fluid power to the solenoid valves which, in turn, are actuated by the controller so as to selectively direct hydraulic fluid throughout the automatic transmission to control modulation of rotational torque generated by the engine. The solenoid valves are also typically used to change between the gear sets of the automatic transmission, and may also be used to control hydraulic fluid used to cool and/or lubricate various components of the transmission in operation.

Depending on the specific configuration of the automatic transmission, clutch modulation and/or gear actuation may necessitate operating the pump assembly so as to pressurize the hydraulic fluid at relatively high magnitudes. Conversely, lubrication and/or cooling typically require significantly lower hydraulic fluid pressure, whereby excessive pressure has a detrimental effect on transmission operation and/or efficiency. Moreover, hydraulic fluid heats up during operation of the automatic transmission, and changes in the temperature of the hydraulic fluid result in a corresponding change in the viscosity of the hydraulic fluid. As such, where specific hydraulic pressure is needed to properly operate the automatic transmission, the volume of hydraulic fluid required to achieve the requisite hydraulic pressure varies with operating temperature. Further, where the pump assembly is driven by the powertrain system, fluid flow is proportional to pump rotational speed. Because fluid flow increases with increased rotational speed, under certain operating conditions, a significant volume of fluid displaced by the pump assembly must be re-circulated to maintain proper fluid flow and pressure requirements throughout the automatic transmission, thereby leading to disadvantageous parasitic loss which results in low efficiency.

Each of the components and systems of the type described above must cooperate to effectively modulate translation of rotational torque from the engine to the wheels of the vehicle. In addition, each of the components and systems must be designed not only to facilitate improved performance and efficiency, but also so as to reduce the cost and complexity of manufacturing the vehicles. While pump assemblies for powertrain systems known in the related art have generally performed well for their intended use, there remains a need in the art for a pump assembly that has superior operational characteristics, reduced overall packaging size, reduced parasitic losses, increased efficiency and, at the same time, reduces the cost and complexity of manufacturing vehicles.

### SUMMARY OF THE INVENTION

The present invention overcomes the disadvantages in the related art in a positive displacement pump assembly for use with a vehicle powertrain system. The pump assembly includes a stator having a chamber and a vane pump disposed in the chamber and cooperating with the chamber so as to define at least three pumping regions in the chamber with each of the at least three pumping regions having an inlet region and an outlet region. Rotation of the vane pump displaces fluid across each of the at least three pumping regions such that each outlet region provides a separate source of fluid power to the powertrain system.

In addition, the present invention is directed toward a hydraulic control system for use with a vehicle powertrain system. The hydraulic control system includes a positive displacement pump assembly, a main line in fluid communication with the powertrain system, and a switching valve. The positive displacement pump assembly includes a stator having a chamber and a rotatable pump member disposed in the chamber and cooperating with the chamber so as to define at least three pumping regions with each of the at least three pumping regions having an inlet region and an outlet region. Rotation of the pump member displaces fluid across each of the at least three pumping regions such that each outlet region provides a separate source of fluid power. The switching valve has a first position, a second position, and a third position. In the first position, fluid power from one of the outlet regions is directed to the main line and fluid power from two of the outlet regions is directed away from the main line. In the second position, fluid power from two of the outlet regions is directed to the main line and fluid power from one of the outlet regions is directed away from the main line. In the third position, fluid power from three of the outlet regions is directed to the main line. The switching valve is selectively movable between the positions so as to control flow of fluid power from the outlet regions to the main line.

In this way, the present invention significantly improves the efficiency of vehicle powertrain systems by providing a pump assembly that can operate at high-efficiency under a number of different operating conditions while, at the same time, providing optimized fluid flow and pressure to various transmission components and systems. Moreover, the present invention affords opportunities for enhanced vehicle efficiency and reduced weight, thereby providing improvements in vehicle fuel economy. Further, the present invention can be used in connection with a number of different types of powertrain systems, and in a number of different ways. Further still, the present invention reduces the cost and complexity of manufacturing vehicles that have superior operational characteristics, such as high efficiency, reduced weight and packaging size, and improved component life.

### BRIEF DESCRIPTION OF THE DRAWINGS

Other objects, features, and advantages of the present invention will be readily appreciated as the same becomes better understood after reading the subsequent description taken in connection with the accompanying drawings wherein:

FIG. 1 is a schematic plan view of a vehicle powertrain system including a positive displacement pump assembly, according to the present invention.

FIG. 2 is a sectional view of a first embodiment of the positive displacement pump assembly, according to the present invention, of FIG. 1.

FIG. 3 is a sectional view of a second embodiment of the positive displacement pump assembly, according to the present invention, of FIG. 1.

FIG. 4 is a schematic view of a first embodiment of a hydraulic control system, according to the present invention, for use with the positive displacement pump assembly of FIG. 1.

FIG. 5 is a schematic view of a second embodiment of a hydraulic control system, according to the present invention, for use with the positive displacement pump assembly of FIG. 1.

### DETAILED DESCRIPTION OF THE INVENTION

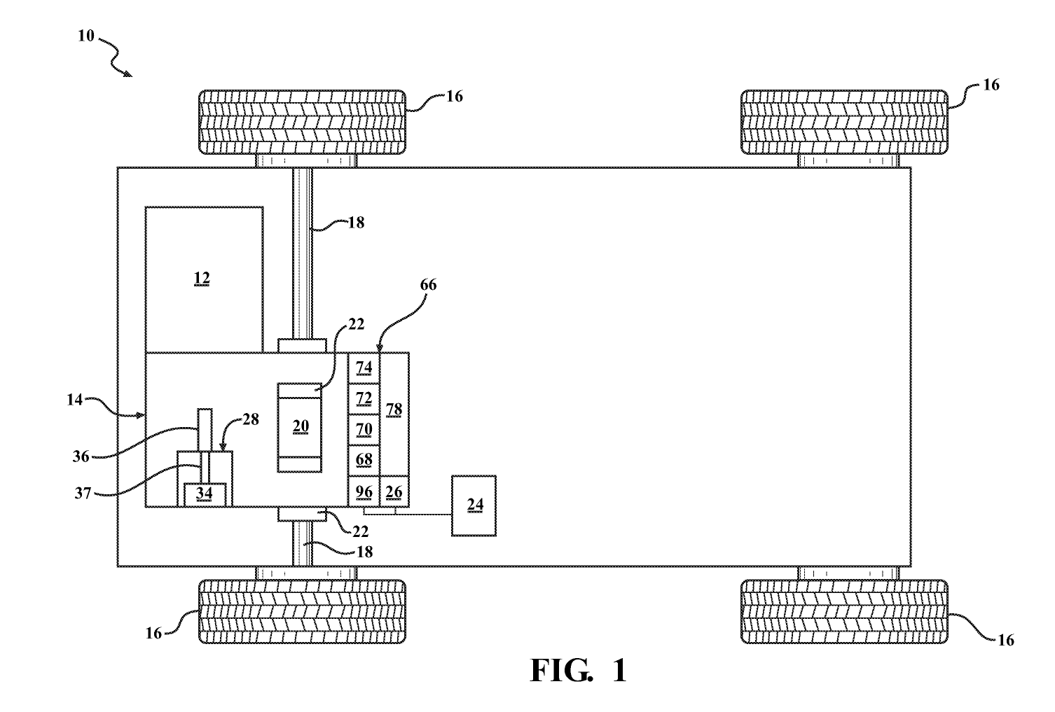

Referring now to the figures, where like numerals are used to designate like structure unless otherwise indicated, a vehicle powertrain system is schematically illustrated at 10 in FIG. 1. The powertrain system 10 includes an engine 12 in rotational communication with an automatic transmission 14. The engine 12 generates rotational torque which is selectively translated to the automatic transmission 14 which, in turn, translates rotational torque to one or more wheels, generally indicated at 16. To that end, a pair of continuously-variable joints 18 translates rotational torque from the automatic transmission 14 to the wheels 16. Those having ordinary skill in the art will recognize the engine 12 and the automatic transmission 14 of FIG. 1 as being of the type employed in conventional “transverse front wheel drive” powertrain systems 10. Moreover, it will be appreciated that the engine 12 and/or the automatic transmission 14 could be of any suitable type, configured in any suitable way, sufficient to generate and translate rotational torque so as to drive the vehicle, without departing from the scope of the present invention. By way of non-limiting example, the engine 12 could be realized by a conventional internal combustion engine, a “hybrid engine” that cooperates with one or more electric motors (not shown, but generally known in the art), or one or more electric motors.

The automatic transmission 14 multiplies the rotational speed and torque generated by the engine 12 through a series of predetermined gear sets 20 (not shown in detail, but generally known in the art), whereby changing between the gear sets 20 enables the vehicle to travel at different vehicle speeds for a given speed of the engine 12. Thus, the gear sets 20 of the automatic transmission 14 are configured such that the engine 12 can operate at particularly desirable rotational speeds so as to optimize vehicle performance and efficiency. In addition to changing between the gear sets 20, the automatic transmission 14 is also used to modulate engagement with the engine 12, whereby the transmission 14 can selectively control engagement with the engine 12 so as to facilitate vehicle operation. By way of example, torque translation between the engine 12 and the automatic transmission 14 is typically interrupted while a vehicle is parked or idling, or when the transmission 14 changes between the gear sets 20. In the automatic transmission 14, modulation of rational torque between the engine 12 and the transmission 14 is achieved via a hydrodynamic device, such as a hydraulic torque converter (not shown, but generally known in the art). However, the current trend in the art involves replacing the torque converter with one or more hydraulically-actuated clutch assemblies 22 (not shown in detail, but generally known in the art). This configuration is sometimes referred to in the art as a “dual clutch” automatic transmission.

Irrespective of the specific configuration of the powertrain system 10, the automatic transmission 14 is typically controlled using hydraulic fluid. Specifically, the automatic transmission 14 is cooled, lubricated, actuated, and modulates torque using hydraulic fluid. To these ends, the automatic transmission 14 typically includes a controller 24 in electrical communication with one or more solenoids 26 (see FIG. 1) used to direct, control, or otherwise regulate flow of fluid throughout the transmission 14, as described in greater detail below. In order to facilitate the flow of hydraulic fluid throughout the automatic transmission 14, the powertrain system 10 includes a positive displacement pump assembly, according to one embodiment of the present invention and generally indicated at 28. The controller 24, solenoids 26, and pump assembly 28 will each be described in greater detail below.

The pump assembly 28 is adapted to provide a source of fluid power to the powertrain system 10. Specifically, the pump assembly 28 provides fluid power to various locations and components of the automatic transmission 14, as described in greater detail below. While the pump assembly 28 is described herein as providing fluid power to the automatic transmission 14 of the powertrain system 10, those having ordinary skill in the art will appreciate that the pump assembly 28 could be used in connection with any suitable part of the powertrain system 10 without departing from the scope of the present invention. By way of non-limiting example, the pump assembly 28 of the present invention could be used to direct or otherwise provide a source of fluid power to the engine 12, a transfer case (not shown, but generally known in the related art), or any other powertrain component that utilizes fluid for lubrication, cooling, control, actuation, and/or modulation. Further, while the present invention is adapted for use with vehicles such as automotive vehicles, it should be appreciated that the pump assembly 28 could be used in connection with any suitable type of vehicle, such as heavy-duty trucks, trains, airplanes, ships, construction vehicles or equipment, military vehicles, recreational vehicles, or any other type of vehicle.

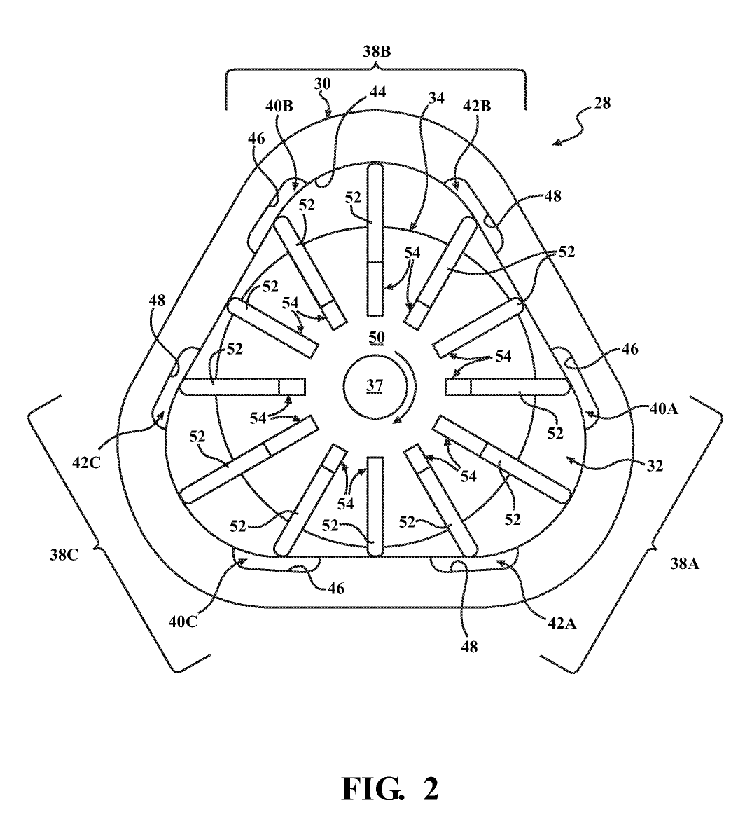

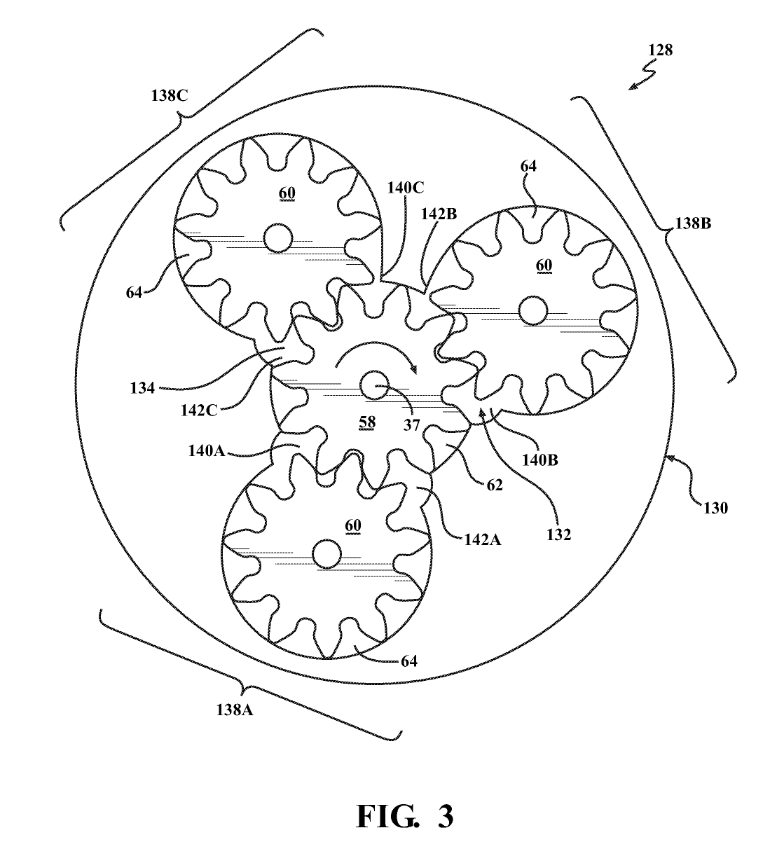

Referring now to FIGS. 2 and 3, the positive displacement pump assembly 28 of the present invention includes a stator 30 having a chamber 32 and a rotatable pump member 34 disposed in the chamber 32 of the stator 30. The pump member 34 is disposed in torque translating relationship with the powertrain system 10. More specifically, the pump member 34 receives rotational torque from a prime mover 36 of the powertrain system 10 (see FIGS. 1, 4 and 5; not shown in detail, but generally known in the art). In the representative embodiment illustrated herein, the pump member 34 is coupled to an input shaft 37 which, in turn, is disposed in rotational communication with the prime mover 36. However, those having ordinary skill in the art will appreciate that the pump assembly 28 could be configured differently, with or without the use of an input shaft 37, without departing from the scope of the present invention. Moreover, it should be appreciated that the pump member 34 could receive rotational torque from the powertrain system 10 in a number of different ways. By way of non-limiting example, the pump member 34 could be directly coupled to the prime mover 36, or one or more geartrains (not shown, but generally known in the art) could be interposed between the pump member 34 and the prime mover 36 so as to adjust the rotational speed and torque therebetween.

In the representative embodiment illustrated herein, the pump assembly 28 is disposed in rotational communication with the prime mover 36 that is supported in the automatic transmission 14. However, those having ordinary skill in the art will appreciate that the prime mover 36 could be realized by any suitable component of the powertrain system 10 without departing from the scope of the present invention. By way of non-limiting example, the prime mover 36 could be realized by a shaft supported in rotational communication with the engine 12 and/or the automatic transmission 14, or the prime mover 36 could be a shaft of an electric motor (not shown, but generally known in the art).

As noted above, the pump member 34 is disposed in the chamber 32 and cooperates with the stator 30 so as to define at least three pumping regions, generally indicated at 38. The pumping regions 38 each have a respective inlet region 40 and a corresponding outlet region 42. Rotation of the pump member 34 within the chamber 32 displaces fluid across each of the pumping regions 38 such that each outlet region 42 provides a respective and separate source of fluid power to the powertrain system 10. Thus, the number of pumping regions 38 correlates to the number of sources of fluid power. The stator 30, chamber 32, and pump member 34 will each be described in greater detail below. It should be appreciated that the pump assembly 28 can be configured in a number of different ways. By way of non-limiting example, two different embodiments of the pump assembly 28 are described herein, each having a differently configured stator 30 and pump member 34. For the purposes of clarity and consistency, unless otherwise indicated, subsequent discussion of the pump assembly 28 will refer to a first embodiment of the pump assembly 28 as shown in FIG. 2.

In one embodiment, the pump member 34 and chamber 32 cooperate so as to define at least three pumping regions 38: a first pumping region 38A with a first inlet region 40A and a first outlet region 42A; a second pumping region 38B with a second inlet region 40B and a second outlet region 42B; and a third pumping region 38C with a third inlet region 40C and a third outlet region 42C. However, as will be appreciated from the subsequent description below, the pump assembly 28 could utilize any suitable additional number of pumping regions 38 without departing from the scope of the present invention. By way of non-limiting example, the specific configuration of the powertrain system 10 could necessitate that more than three pumping regions 38 be utilized.

As noted above, rotation of the pump member 34 displaces fluid across each of the pumping regions 38. In one embodiment, a substantially equivalent volume of fluid is displaced across each of the pumping regions 38 during rotation of the pump member 34. However, those having ordinary skill in the art will appreciate that the stator 30, chamber 32, and/or pump member 34 could be configured so as to displace respectively different volumes of fluid across the pumping regions 38 during rotation of the pump member 34, without departing from the scope of the present invention. By way of non-limiting example, two pumping regions 38A, 38B could displace the same volume of fluid, and a third pumping region 38C could displace a greater volume of fluid.

As shown in FIG. 2, the pump member 34 is disposed within the chamber 32 of the stator 30 such that rotation of the pump member 34 displaces fluid across the pumping regions 38, as noted above. In one embodiment, the pump member 34 is positioned so as to be substantially concentrically aligned within the chamber 32. However, those having ordinary skill in the art will appreciate that the pump member 34, chamber 32, and/or stator 30 could be configured differently, or otherwise defined in any suitable way sufficient to displace fluid across the pumping regions 38, without departing from the scope of the present invention. In one embodiment, the chamber 32 of the stator 30 is generally three-sided with apexes formed by a curved profile (see FIG. 2). However, those having ordinary skill in the art will appreciate that the chamber 32 could have any suitable profile, defined by any suitable shape or with any configuration sufficient to cooperate with the pump member 34 as discussed above, without departing from the scope of the present invention (compare FIG. 2 to the second embodiment of the pump assembly 28 shown in FIG. 3). Moreover, and by way of illustrative example, where more than three pumping regions 38 are required, it is conceivable that the chamber 32 could have a profile defined by a different shape that corresponds to the required number of pumping regions 38.

In the first embodiment illustrated in FIG. 2, the chamber 32 defines an inner chamber surface 44, the inlet regions 40 are further defined as inlet ports 46, and the outlet regions 42 are further defined as outlet ports 48. The inlet ports 46 are disposed in spaced relationship about the inner chamber surface 44. Similarly, the outlet ports 48 are also disposed in spaced relationship about the inner chamber surface 44. In the representative example illustrated herein, the inlet ports 46 are arranged between the outlet ports 48, with each of the adjacent ports 46, 48 being spaced substantially evenly from one another. However, those having ordinary skill in the art will appreciate that the ports 46, 48 could be arranged, configured, and/or spaced in any suitable way without departing from the scope of the present invention. Further, while the inlet ports 46 and outlet ports 48 are similarly sized, those having ordinary skill in the art will appreciate that the inlet ports 46 and/or outlet ports 48 could each be sized, shaped, or otherwise configured in any suitable way without departing from the scope of the present invention.

In the embodiment of the pump assembly 28 illustrated in FIG. 2, the pump member 34 is a vane pump that includes a rotor 50 supporting a plurality of vanes 52. The vanes 52 each at least partially engage the inner chamber surface 44 and are arranged such that rotation of the rotor 50 causes the vanes 52 to traverse the inner chamber surface 44, thereby displacing fluid from each of the inlet ports 46 to each respective outlet port 48. Those having ordinary skill in the art will recognize this embodiment of the positive displacement pump assembly 28 of the present invention as having what is commonly referred to in the related art as a “vane pump” configuration.

The vanes 52 are disposed in spaced relation about the rotor 50. More specifically, the vanes 52 are annularly spaced about and extend radially from the rotor 50. However, those having ordinary skill in the art will appreciate that the vanes 52 could be spaced, arranged, or otherwise configured in any suitable way without departing from the scope of the present invention. In one embodiment, the rotor 50 includes a plurality of radially-spaced slots 54, with each of the vanes 52 slidably supported and moveable within one of the respective slots 54. Further, in one embodiment, a biasing member (not shown) may be interposed between the rotor 50 and each of the vanes 52 for urging the vanes 52 against the inner chamber surface 44. The biasing members may be compression springs. It should be appreciated that the biasing members are optional and could be configured differently, or could be omitted entirely, without departing from the scope of the present invention.

During a complete rotation of the pump member 34 within the chamber 32, each vane 52 at least partially engages fluid and successively traverses each inlet region 40 and each outlet region 42. Thus, in one embodiment, the pump member 34 is disposed in fluid communication with each of the inlet regions 40 and also with each of the outlet regions 42. However, those having ordinary skill in the art will appreciate that the pump member 34 could be configured in a number of different ways and, thus, the pump member 34 could be disposed in fluid communication with the pumping regions 38 differently without departing from the scope of the present invention. Specifically, and as will be appreciated from the subsequent description of the second embodiment depicted in FIG. 3 and described in greater detail below, the pump member 34 could be configured so as to omit vanes 52 entirely without departing from the scope of the present invention.

As noted above, a second embodiment of the positive displacement pump assembly 28 of the present invention is shown in FIG. 3. In the description that follows, like components of the second embodiment of the pump assembly 28 are provided with the same reference numerals used in connection with the first embodiment of the pump assembly 28, and different components are provided with reference numerals increased by 100.

Referring now to FIG. 3, in the second embodiment of the pump assembly 128, the pump member 134 includes a rotatable drive gear 58 and a plurality of driven gears 60 arranged about the drive gear 58 such that rotation of the drive gear 58 causes corresponding rotation of the driven gears 60. In this embodiment, the inlet regions 140 and the outlet regions 142 are arranged in spaced relationship with the driven gears 60 such that rotation of the drive gear 58 causes the driven gears 60 to displace fluid from each of the inlet regions 140 to each respective outlet region 142. Those having ordinary skill in the art will recognize this embodiment of the positive displacement pump assembly 128 of the present invention as having what is commonly referred to in the related art as a “gear pump” configuration. In this embodiment, the chamber 132 of the stator 130 includes a central pocket 62 for accommodating the drive gear 58, and a plurality of outer pockets 64 arranged about and merging with the central pocket 64 for accommodating the respective driven gears 60. In this embodiment, the pumping regions 138, inlet regions 140, and/or outlet regions 142 are defined by the spacing between the pockets 62, 64 and/or the gears 58, 60. However, as noted above, those having ordinary skill in the art will appreciate that the pumping regions 138 could be defined in any suitable way without departing from the scope of the present invention.

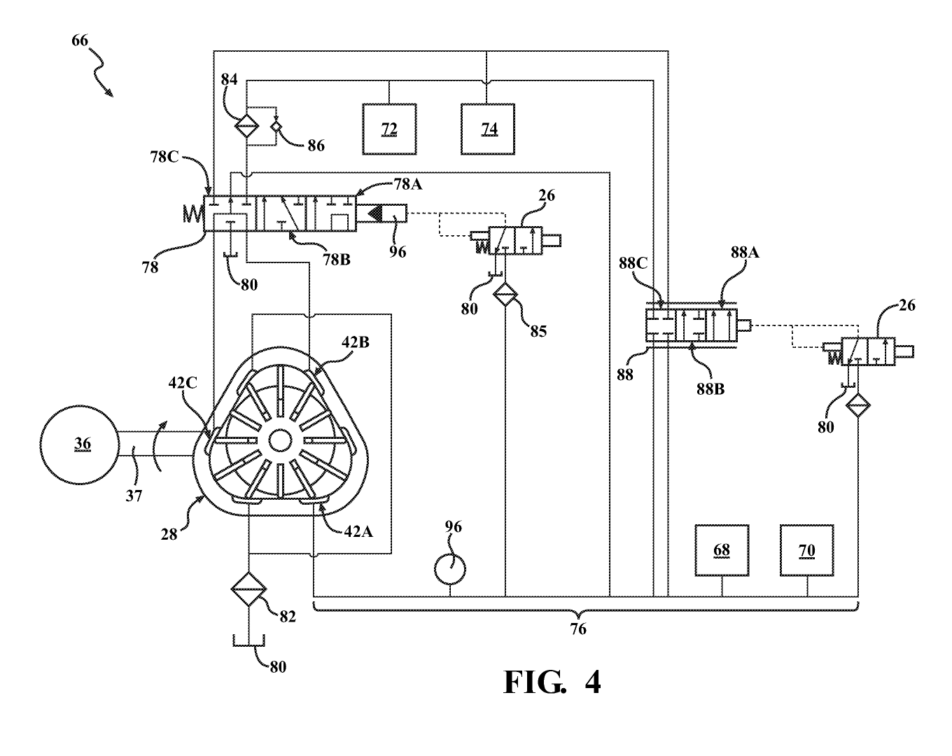

As noted above, the present invention is also directed toward a hydraulic control system, according to the present invention and generally indicated at 66, for use with the powertrain system 10. The control system 66 directs or otherwise controls fluid power from the pumping regions 38A, 38B, 38C of the pump assembly 28 to the powertrain system 10, as described in greater detail below. It will be appreciated that the hydraulic control system 66 can be configured in a number of different ways. By way of non-limiting example, two different embodiments of the hydraulic control system 66 are described herein, each being configured to direct fluid to the automatic transmission 14 in different ways. For the purposes of clarity and consistency, unless otherwise indicated, subsequent discussion of the hydraulic control system 66 will refer to a first embodiment of the hydraulic control system as shown in FIG. 4.

Referring now to FIG. 4, a first embodiment of the hydraulic control system 66 and pump assembly 28 is shown in connection with the automatic transmission 14. As noted above, the automatic transmission 14 utilizes hydraulic fluid for lubrication, actuation, modulation, and/or control. To that end, the automatic transmission 14 includes a clutch actuation circuit 68, a gear shift actuation circuit 70, a clutch lubrication circuit 72, and a gearbox lubrication circuit 74. The clutch actuation circuit 68 is used to selectively actuate the clutch assemblies 22 so as to modulate rotational torque between the engine 12 and the automatic transmission 14. The gear shift actuation circuit 70 is used to selectively switch between the gear sets 20 of the automatic transmission 14. The clutch lubrication circuit 72 is used control flow of hydraulic fluid to the clutch assemblies 22 for cooling and lubrication. Similarly, the gearbox lubrication circuit 74 is used to control flow of hydraulic fluid to other locations throughout the automatic transmission 14, such as shafts, bearings, gears, and the like (not shown in detail, but generally known in the art), for cooling and lubrication. Those having ordinary skill in the art will appreciate that there are a number of different ways that the circuits described above could be configured. As such, each of the circuits 68, 70, 72, 74 is depicted generically. Moreover, it will be appreciated that the hydraulic control system 66 could be used to direct fluid power to any suitable number of circuits, configured in any suitable way and for any suitable purpose of the powertrain system 10, without departing from the scope of the present invention. Similarly, while the representative embodiments illustrated herein describe the hydraulic control system 66 as used with hydraulic fluid in the automatic transmission 14, those having ordinary skill in the art will appreciate that the hydraulic control system 66 and pump assembly 28 can be adapted to displace or otherwise direct any suitable type of fluid to any suitable component or system of the powertrain system 10 of any suitable type or configuration without departing from the scope of the present invention.

Those having ordinary skill in the art will appreciate that each of the circuits 68, 70, 72, 74 may require respectively different pressure and/or flow requirements. By way of non-limiting example, in the representative embodiment of the hydraulic control system 66 described herein, the clutch actuation circuit 68 and the gear shift actuation circuit 70 require a relatively high or first hydraulic fluid pressure (for example, ˜15-20 bar), the clutch lubrication circuit 72 requires a medium or second hydraulic fluid pressure (for example, ˜2 bar), and the gearbox lubrication circuit 74 requires a low or third hydraulic fluid pressure (for example, <0.5 bar). To facilitate the competing flow and pressure requirements of the circuits 68, 70, 72, 74, the hydraulic control system 66 includes a main line, generally indicated at 76, and a switching valve 78 that cooperate with the pump assembly 28. In the representative embodiment illustrated herein, the main line 76 is disposed in fluid communication with the outlet region 42A of the pump assembly 28, the switching valve 78, and the clutch actuation circuit 68 and the gear shift actuation circuit 70. It should be appreciated that the clutch actuation circuit 68 and the gear shift actuation circuit 70 have the highest relative hydraulic fluid pressure requirements of the automatic transmission 14. It should also be appreciated that the main line 76 could be defined in any suitable way, disposed in fluid communication with any suitable component or circuit of the hydraulic control system 66, without departing from the scope of the present invention.

As noted above, the hydraulic control system 66 includes a switching valve 78. The switching valve 78 has a first position 78A, a second position 78B, and a third position 78C.

In this embodiment, when the switching valve 78 is in the first position 78A, fluid power from one of the outlet regions 42A is directed to the main line 76 and fluid power from the other two outlet regions 42B, 42C is directed away from the main line 76. When the switching valve 78 is in the second position 78B, fluid power from two of the outlet regions 42A, 42B is directed to the main line 76 and fluid power from the other outlet region 42C is directed away from the main line 76. When the switching valve 78 is in the third position 78C, fluid power from all three of the outlet regions 42A, 42B, 42C is directed to the main line 76. The switching valve 78 is selectively moveable between the positions 78A, 78B, 78C so as to control flow of fluid power from the outlet regions 42A, 42B, 42C of the pump assembly 28 to the main line 76.

As will be appreciated from the subsequent description below, the positions 78A, 78B, 78C of the switching valve 78 described above enable the pump assembly 28 to combine fluid power from the three outlet regions 42A, 42B, 42C in predetermined ways so as to ensure proper hydraulic fluid pressure at the main line 76 under different operating conditions of the automatic transmission 14. In the exemplary embodiment of the positions 78A, 78B, 78C described above and illustrated in FIG. 4, the hydraulic control system 66 directs fluid power from all three outlet regions 42A, 42B, 42C to the main line 76 when the switching valve 78 is in the third position 78C. However, those having ordinary skill in the art will appreciate that the automatic transmission 14 and/or hydraulic control system 66 could have significantly different operating requirements, depending on the application. Thus, it will be appreciated that the switching valve 78 could be configured with any suitable number of positions adapted to direct fluid from the pump assembly 28 in a number of different ways, without departing from the scope of the present invention. It should be appreciated that the hydraulic control system 66 could be configured such that when the switching valve 78 is in a certain position, fluid power from all three outlet regions 42A, 42B, 42C is directed somewhere other than to the main line 76.

In one embodiment, the hydraulic control system 66 includes a sump 80 for providing a source of hydraulic fluid to the inlet regions 40 of the pump assembly 28. More specifically, the sump 80 is adapted to store non-pressurized hydraulic fluid, and is disposed in fluid communication with all three inlet regions 40A, 40B, 40C of the pump assembly 28. However, while the hydraulic control system 66 depicted herein utilizes a common sump 80 for all three inlet regions 40A, 40B, 40C, it should be appreciated that a plurality of sumps 80 could be utilized. By way of non-limiting example, each inlet region 40A, 40B, 40C could be disposed in fluid communication with a different sump (not shown, but generally known in the art). In one embodiment, when the switching valve 78 is in the first position 78A and/or the second position 78B, fluid power directed away from the main line 76 is at least partially directed to the sump 80. Similarly, when the switching valve 78 is in the first position 78A and/or the second position 78B, fluid power directed away from the main line 76 is at least partially directed to the clutch lubrication circuit 72 and/or to the gearbox lubrication circuit 74.

As noted above, the hydraulic control system 66 directs hydraulic fluid from a common sump 80. In order to ensure long life of the automatic transmission 14, a suction filter 82 may be disposed in fluid communication between the sump 80 and the inlet regions 40 of the pump assembly 28. The suction filter 82 protects the pump assembly 28 from particulates and other contamination that may accumulate in the hydraulic fluid. Likewise, a pressure filter 84 may be disposed between the switching valve 78 and one or more of the circuits 68, 70, 72, 74 so as to provide additional filtering protection from contamination, such as particulates deposited in the hydraulic fluid by the pump assembly 28. Similarly, one or more additional auxiliary filters 85 may be used to protect the solenoid valves 26 from contamination. In one embodiment, a filter check valve 86 is disposed in parallel with the pressure filter 84. The filter check valve 86 allows fluid to effectively bypass the pressure filter 84 under certain operating conditions, such as when the pressure filter 84 becomes clogged and would otherwise restrict flow of hydraulic fluid.

In one embodiment, the hydraulic control system 66 includes a pressure regulator valve 88 interposed in fluid communication between the main line 76 and the clutch lubrication circuit 72 and/or gearbox lubrication circuit 74. The pressure regulator valve 88 cooperates with the switching valve 78 so as to direct fluid power from the outlet regions 42A, 42B, 42C of the pump assembly 28 so as to accommodate the pressure and flow requirements of the circuits 68, 70, 72, 74 and ensure proper operation under different operating conditions. The pressure regulator valve 88 regulates the line pressure of the main line 76 in responding to instantaneous clutch and gear shifting pressure demand. It should be appreciated that regulating and maintaining the correct line pressure by the pressure regulator valve 88 ensures the proper operation of the powertrain system 10.

Specifically, the pressure regulator valve 88 shown in FIG. 4 has a first pressure regulator position 88C, a second pressure regulator position 88B, and a third pressure regulator position 88A. When the pressure regulator valve 88 is in the first pressure regulator position 88C, when the engine is at low speed, such as idle, the flow is limited. The pressure regulator valve 88 is fully closed so that all the flow from the pump assembly 28 is used to create the pressure needed. When the pressure regulator valve 88 is in the second pressure regulator position 88B, while engine speed increases, the pump flow increases proportionally due to the fixed ratio between the pump assembly 28 and the prime mover 36. At such position, a port opens and partial flow will be directed to the clutch lubrication circuit 72 and/or the gearbox lubrication circuit 74 for the purpose of clutch and gearbox lubrication/cooling. When the pressure regulator valve 88 is in the third pressure regulator position 88A, at even higher engine speed, after satisfying the line pressure demand and lubrication/cooling demand, any more excess flow is routed back to the pump inlet regions 40 through the suction return fluid circuit to prevent higher drag torque caused by high fluid flow in the clutch assemblies 22 and other components. The pressure regulator valve 88 is selectively movable between the regulator positions 88A, 88B, 88C so as to cooperate with the switching valve 78 as noted above. Those having ordinary skill in the art will appreciate that the positions 88A, 88B, 88C of the pressure regulator valve 88 may correlate with the positions 78A, 78B, 78C, of the switching valve 78 or may be selected independent and irrespective of the positions 78A, 78B, 78C of the switching valve 78. As is described in greater detail below, the pressure regulator valve 88 and the switching valve 78 can be controlled, configured, oriented, or disposed in a number of different ways. It should be appreciated that the pressure regulator valve 88 is a proportional valve and has infinite positions when it is continuously regulating even though there are only three positions described. It should also be appreciated that the pressure regulator valve 88 could be omitted from the hydraulic control system 66 without departing from the scope of the present invention.

As noted above, the hydraulic control system 66 may include the controller 24 in electrical communication with one or more of the solenoid valves 26 used to control the switching valve 78. In one embodiment, the switching valve 78 is further defined as a spring-biased valve member having a hydraulic switch inlet 90. The controller 24, via the solenoid valve 26, controls the switching valve 78, whereby the solenoid valve 26 is interposed in fluid communication between the main line 76 and the hydraulic switch inlet 90. More specifically, in this embodiment, the solenoid valve 26 is realized as a proportioning solenoid valve 100 adapted to move the valve member of the switching valve 78 between the positions 78A, 78B, 78C. To that end, the controller 24 is adapted to actuate the proportioning solenoid valve 100 so as to selectively move the hydraulic switching valve 78 between the positions 78A, 78B, 78C. While a proportioning-style valve is described herein, it will be appreciated that there are many different types of solenoid valves 26 known in the related art. Thus, the switching valve 78 and/or the proportioning valve 100 could be of any suitable type, controlled in any suitable way, without departing from the scope of the present invention. By way of non-limiting example, solenoid valves 26 are known in the related art that may be cycled, such as by pulse width modulation (PWM), or may include variable position functionality, actuated such as with a stepper motor or an additional solenoid (not shown, but generally known in the art).

The controller 24, sometimes referred to in the related art as an “electronic control module,” may also be used to control other components of the automatic transmission 14. By way of non-limiting example, another solenoid valve 26, such as a secondary proportioning solenoid valve 102, may be used to control the pressure regulator valve 88 between the pressure regulator positions 88A, 88B, 88C (see FIG. 4). Further, in one embodiment, the hydraulic control system 66 includes at least one sensor 96 disposed in fluid communication with the main line 76 and disposed in electrical communication with the controller 24 (electrical connection not shown in detail, but generally known in the art). The sensor 96 generates a signal representing at least one of hydraulic pressure, temperature, viscosity, and/or flowrate. The controller 24 may be configured to monitor the sensor 96 and actuate the proportioning solenoid valve 100 in response to predetermined changes in the signal generated by the sensor 96 so as to move the valve member of the switching valve 78 between the positions 78A, 78B, 78C. In one embodiment, the sensor 96 is a pressure transducer for generating a signal representing the hydraulic fluid pressure occurring at the main line 76. While a single sensor 96 is utilized in the representative embodiment illustrated herein, those having ordinary skill in the art will appreciate that the hydraulic control system 66 could include any suitable number of sensors, of any suitable type, arranged in any suitable way, without departing from the scope of the present invention.

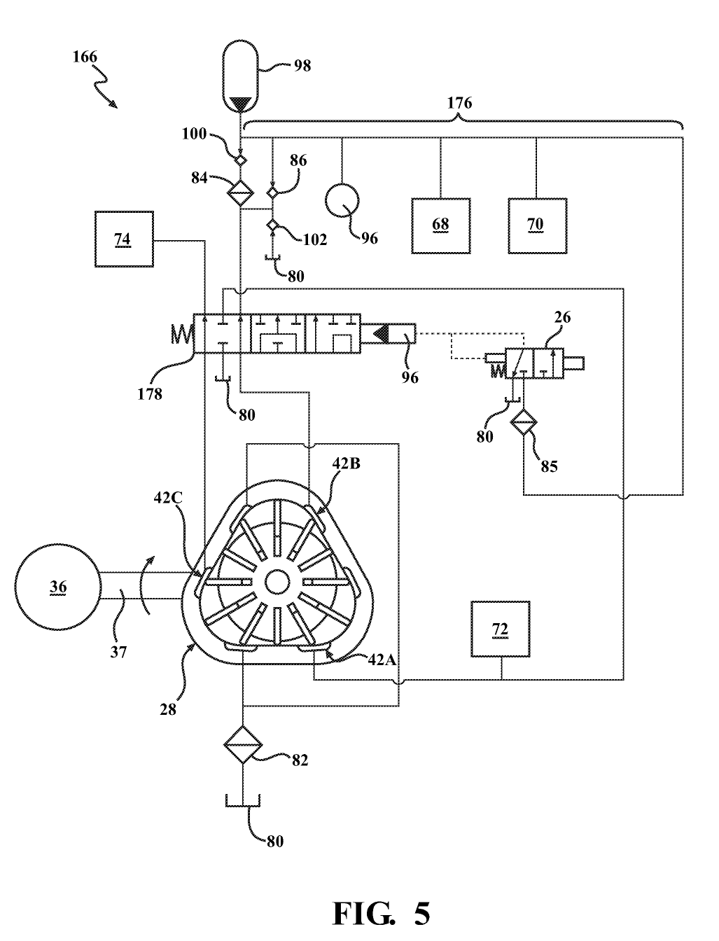

As noted above, a second embodiment of the hydraulic control system 66 of the present invention is shown in FIG. 5. In the description that follows, like components of the second embodiment of the hydraulic control system are provided with the same reference numerals used in connection with the first embodiment of the hydraulic control system 66, and different components are provided with reference numerals increased by one hundred (100).

Referring now to FIG. 5, the second embodiment of the hydraulic control system 166 includes an accumulator 98 disposed in fluid communication with the main line 176 for storing pressurized hydraulic fluid. More specifically, the accumulator 98 is adapted to store hydraulic fluid under certain operating conditions of the automatic transmission 14 so that pressurized fluid energy can subsequently be made available at the main line 176 under different operating conditions of the automatic transmission 14. The accumulator 98 is a conventional gas-charged hydraulic accumulator, but those having ordinary skill in the art will appreciate that the accumulator 98 could be of any suitable type, or could be omitted entirely, without departing from the scope of the present invention. In one embodiment, an accumulator check valve 100 is used to prevent back-flow of fluid from the accumulator 98 toward the switching valve 178. In one embodiment, the hydraulic control system 166 also includes a pressure relief valve 102 disposed in fluid communication between the main line 176 and the sump 180. It should be appreciated that the pressure relief valve 102 is used to bleed off excess hydraulic pressure so as to prevent an over-pressure condition.

In this way, the positive displacement pump assembly 28, 128 and hydraulic control system 66, 166 of the present invention significantly improve the efficiency of vehicle powertrain systems 10 by providing a plurality of sources of fluid power while, at the same time, significantly minimizing parasitic losses, packaging size, and weight. In particular, the pump assembly 28, 128 facilitates compensating for changes in prime mover speed and hydraulic fluid viscosity without necessitating pumping and subsequently bypassing a large volume of fluid, while providing adequate fluid pressure during different operating conditions. Thus, the present invention ensures proper responsiveness and consistent operation of the powertrain system 10 in a simple and cost effect manner. Further, the present invention reduces the cost and complexity of manufacturing vehicles that have superior operational characteristics, such as high efficiency, reduced weight, and improved emissions, component packaging, component life, and vehicle drivability.

The present invention has been described in an illustrative manner. It is to be understood that the terminology which has been used is intended to be in the nature of words of description rather than of limitation.

Many modifications and variations of the present invention are possible in light of the above teachings. Therefore, within the scope of the appended claims, the invention may be practiced other than as specifically described.

1. A positive displacement pump assembly (28) for use with a vehicle powertrain system (10), said pump assembly (28) comprising:
a stator (30) having a chamber (32); and
a vane pump (34) disposed in said chamber (32) and cooperating with said stator (30) so as to define at least three pumping regions (38) in said chamber (32) with each of said at least three pumping regions (38) having an inlet region (40) and an outlet region (42), wherein rotation of said vane pump (34) displaces fluid across each of said at least three pumping regions (38) such that each said outlet region (42) provides a separate source of fluid power to the powertrain system (10).

2. The positive displacement pump assembly (28) as set forth in claim 1, wherein said vane pump (34) is in fluid communication with each said inlet region (40) and each said outlet region (42).

3. The positive displacement pump assembly (28) as set forth in claim 1, wherein said vane pump (34) is concentrically aligned with said chamber (32).

4. The positive displacement pump assembly (28) as set forth in claim 1, wherein said chamber (32) is generally three-sided with apexes formed by a curved profile.

5. The positive displacement pump assembly (28) as set forth in claim 1, wherein said chamber (32) defines an inner chamber surface (44).

6. The positive displacement pump assembly (28) as set forth in claim 5, wherein said inlet region (40) is defined as an inlet port (46) disposed in spaced relationship about said inner chamber surface (44).

7. The positive displacement pump assembly (28) as set forth in claim 6, wherein said outlet region (42) is defined as an outlet port (48) disposed in spaced relationship about said inner chamber surface (44).

8. The positive displacement pump assembly (28) as set forth in claim 7, wherein each said inlet port (46) is arranged between a pair of each said outlet port (48).

9. The positive displacement pump assembly (28) as set forth in claim 7, wherein said vane pump (34) includes a rotor (50) supporting a plurality of vanes (52) at least partially engaging said inner chamber surface (44) and arranged such that rotation of said rotor (50) causes said vanes (52) to traverse said inner chamber surface (44) thereby displacing fluid from each said inlet port (46) to each said outlet port (48).

10. The positive displacement pump assembly (28) as set forth in claim 9, wherein said rotor (50) includes a plurality of slots (54) with each of said vanes (52) slidably supported and moveable within one of said slots (54).

11. A hydraulic control system (66, 166) for use with a vehicle powertrain system (10), said hydraulic control system (66, 166) comprising:
a positive displacement pump assembly (28) including a stator (30) having a chamber (32) and a pump member (34) disposed in and cooperating with said chamber (32) so as to define at least three pumping regions (38) each having an inlet region (40) and an outlet region (42), wherein rotation of said pump member (34) displaces fluid across each of said at least three pumping regions (38) such that each said outlet region (42) provides a separate source of fluid power;
a main line (76, 176) in fluid communication with the powertrain system (10); and
a switching valve (78, 178) having:
a first position wherein fluid power from one said outlet region (42) is directed to said main line (76, 176) and wherein fluid power from two of each said outlet region (42) is directed away from said main line (76, 176),
a second position wherein fluid power from two of each said outlet region (42) is directed to said main line (76, 176) and wherein fluid power from one said outlet region (42) is directed away from said main line (76, 176), and
a third position wherein fluid power from three of each said outlet region (42) is directed to said main line (76, 176); and
said switching valve (78, 178) being selectively movable between said positions so as to control flow of fluid power from each said outlet region (42) to said main line (76, 176).

12. The hydraulic control system (66, 166) as set forth in claim 11, further including a sump (80) for providing a source of hydraulic fluid to said inlet region (40).

13. The hydraulic control system (66, 166) as set forth in claim 12, wherein fluid power directed away from said main line (76, 176) is at least partially directed to said sump (80) when said switching valve (78, 178) is in said first position and/or said second position.

14. The hydraulic control system (66, 166) as set forth in claim 11, further including a lubrication circuit (74) for facilitating powertrain lubrication of the powertrain system (10); and
wherein fluid power directed away from said main line (76, 176) is at least partially directed to said lubrication circuit (74) when said switching valve (78, 178) is in said first position and/or said second position.

15. The hydraulic control system (166) as set forth in claim 14, further including an accumulator (98) disposed in fluid communication with said main line (176) for storing pressurized hydraulic fluid.

16. The hydraulic control system (166) as set forth in claim 14, wherein said switching valve (178) is further defined as a spring-biased valve member having a hydraulic switch inlet (90); and
wherein said hydraulic control system (166) further includes a proportioning solenoid valve (100) disposed in fluid communication between said main line (176) and said hydraulic switch inlet (90) for moving said valve member between said positions.

17. The hydraulic control system (166) as set forth in claim 16, further including a controller (24) in electrical communication with said proportioning solenoid valve (100), said controller (24) being adapted to actuate said proportioning solenoid valve (100) so as to selectively move said valve member between said positions.

18. The hydraulic control system (166) as set forth in claim 17, further including at least one sensor (96) disposed in fluid communication with said main line (176) and disposed in electrical communication with said controller (24), said sensor (96) generating a signal representing at least one of hydraulic fluid pressure, temperature, viscosity, and/or flowrate; and
wherein said controller (24) actuates said proportioning solenoid valve (100) at least partially in response to predetermined changes in said signal generated by said sensor (96) so as to move said valve member between said positions.
